(19) United States
(12) Patent Application Publication
(10) Pub. No.: US 2021/0215798 A1
(43) Pub. Date: Jul. 15, 2021

(54) LIDAR SYSTEM

(71) Applicant: Continental Automotive Systems, Inc., Auburn Hills, MI (US)

(72) Inventors: Pushkar P. Pandit, Cupertino, CA (US); Jacob A. Bergam, Santa Barbara, CA (US); William F. Borba, Santa Barbara, CA (US)

(73) Assignee: Continental Automotive Systems, Inc., Auburn Hills, MI (US)

(21) Appl. No.: 16/739,937

(22) Filed: Jan. 10, 2020

(51) Int. Cl. G01S 7/481; G01S 7/4861; G01S 17/931

(52) U.S. Cl. CPC G01S 7/4813; G01S 17/931; G01S 7/4861

(57) ABSTRACT

A Lidar system includes a photodetector having a field of view. The system includes a light emitter and an exit window positioned to transmit light from the light emitter into a field of illumination overlapping the field of view. The system includes a light-intensity pattern element between the light emitter and the exit window and designed to apply a pattern in the intensity of light across the field of illumination.

### BACKGROUND

A Lidar system includes a photodetector, or an array of photodetectors. Light is emitted into the field of view of the photodetector. The photodetector detects light that is reflected by an object in the field of view. For example, a flash Lidar system emits pulses of light, e.g., laser light, into essentially the entire the field of view. The detection of reflected light is used to generate a 3D environmental map of the surrounding environment. The time of flight of the reflected photon detected by the photodetector is used to determine the distance of the object that reflected the light.

The Lidar system may be mounted on a vehicle to detect objects in the environment surrounding the vehicle and to detect distances of those objects for environmental mapping. The output of the Lidar system may be used, for example, to autonomously or semi-autonomously control operation of the vehicle, e.g., propulsion, braking, steering, etc. Specifically, the system may be a component of or in communication with an advanced driver-assistance system (ADAS) of the vehicle.

Some applications, e.g., in a vehicle, include several Lidar systems. For example, the multiple system may be aimed in different directions and/or may detect light at different distance ranges, e.g., a short range and a long range.

### BRIEF DESCRIPTION OF THE DRAWINGS

FIG. 1 is a perspective view of a vehicle having a flash Lidar system and a scanning Lidar system.

FIG. 2 is a schematic illustrating a cross section of an example of an illumination system of a flash Lidar system.

FIG. 3 is a perspective view of an example of an optical element of the Lidar system of FIG. 2, the optical element being a lens that includes an etching forming a light-intensity pattern element.

FIG. 4 is a perspective view of another example of the optical element of the Lidar system of FIG. 2, the optical element being in a liquid-crystal lens including an array of pixels forming a light-intensity pattern element.

FIG. 4A is a magnified view of FIG. 4.

FIG. 5 is a perspective view of another example of the optical element of the Lidar system of FIG. 2, the optical element being in a lens including an array of micro lenses forming a light-intensity pattern element.

FIG. 5A is a magnified view of FIG. 5.

FIG. 6 is a schematic illustrating a cross section of another example of an illumination system of a flash Lidar system.

FIG. 7 is a perspective view of an example of the optical element of the Lidar system of FIG. 6, the optical element including an array of micro mirrors forming a light-intensity pattern element.

FIG. 7A is a magnified view of FIG. 7.

FIG. 8 is a schematic illustrating a cross section of a scanning Lidar system.

FIG. 9 is a block diagram of a Lidar system.

FIG. 10 is a flow chart illustrating a process for operating a Lidar system.

### DETAILED DESCRIPTION

With reference to the Figures, wherein like numerals indicate like parts throughout the several views, a Lidar system 20, 120, 220 (hereinafter referred to as “system”) includes a light sensor 50 including a photodetector 22, e.g., one photodetector 22 or an array of photodetectors 22 (hereinafter referred to as “photodetector 22”), having a field of view FOV. The system 20, 120, 220 includes a light emitter 30 and an exit window 24 positioned to transmit light from the light emitter 30 into a field of illumination FOI overlapping the field of view FOV. The system 20, 120, 220 includes a light-intensity pattern element 32 between the light emitter 30 and the exit window 24 and designed to apply a pattern 34 in the intensity of light across the field of illumination FOI.

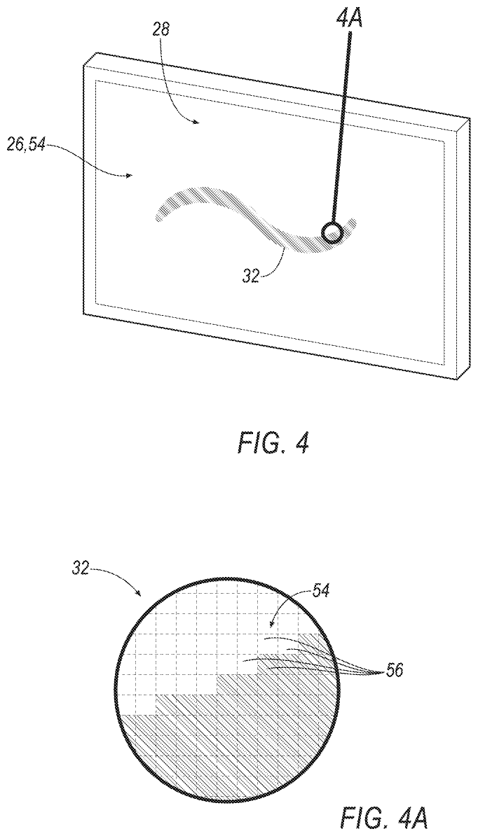

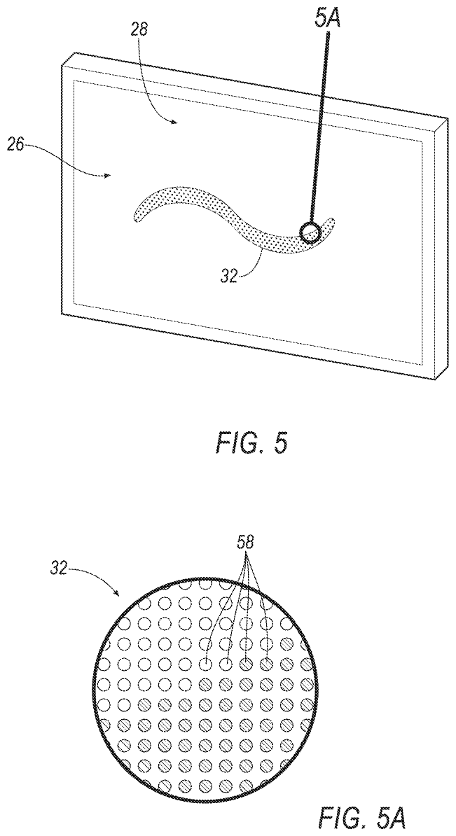

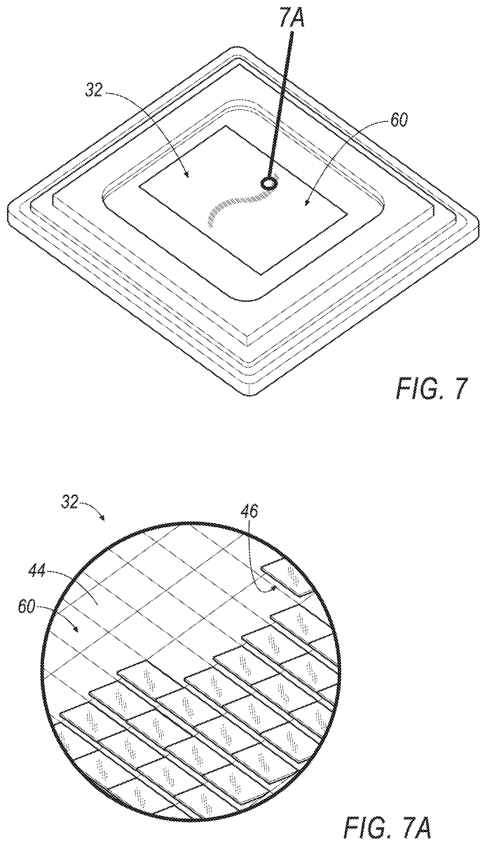

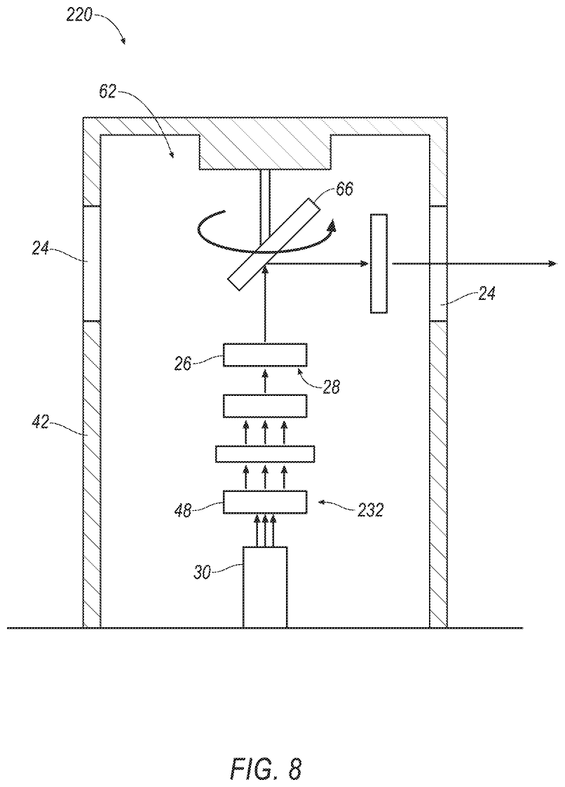

In examples shown in the Figures, the system 20, 120 includes an optical element 26 and the light-intensity pattern element 32 may be a component of the optical element 26. For example, as shown in FIG. 3, the optical element 26 may be a monolithic optical lens 52 (e.g., glass or plastic) having a light-shaping region 28 and the light-intensity pattern element 32 is fixed to the light-shaping region 28. For example, the light-intensity pattern element 32 in FIG. 3 is a surface pattern formed on the light-shaping region 28 of the monolithic lens 52, e.g., etching, added polymer, etc., on the surface of the monolithic lens 52. As another example, as shown in FIGS. 4 and 4A, the optical element 26 is a liquid-crystal lens 54 having a light-shaping region 28 including an array of liquid-crystal pixels 56. In such an example, the array of liquid-crystal pixels 56 is the light-intensity pattern element 32. Specifically, in the example shown in FIGS. 4 and 4A, the optical element 26 may be a spatial light modulator. As another example, as shown in FIGS. 5 and 5A, the optical element 26 includes an array of micro lenses 58 forming the light-shaping region 28. In such an example, the array of micro lenses 58 is the light-intensity pattern element 32. As another example, as shown in FIGS. 7 and 7A, the optical element 26 includes an array of micro mirrors 60. In such an example, the array of micro mirrors 60 is the light-intensity pattern element 32. As another example shown in FIG. 8, the light-intensity pattern element 232 of the system 220 may be a variable optical attenuator 48. The variable optical attenuator 48 selectively reduces intensity of light from the light emitter 30, e.g., in response to a command from the computer 38.

A method for controlling the system 20, 120, 220 includes activating the light emitter 30 to emit light with the emitted light having the intensity pattern 34 across the field of illumination FOI overlapping the field of view of the photodetector(s) 22. The method includes receiving data from the photodetector(s) 22 indicating detection of light from the light emitter 30 that was reflected in the field of view FOV with the data specifying an intensity profile. The method includes normalizing the data from the photodetector(s) 22 to remove the intensity pattern 34 of the light emitted by the light emitter 30. The method may be performed with a computer 38 having a processor and a memory storing instructions executable by the processor to execute to the method.

The system 20, 120, 220 and method reduce interference of light generated from a source other than the light emitter 30 and detected by the photodetector(s) 22. Light detected by the photodetector(s) 22 that is generated from a source other than the light emitter 30 may cause data generated by the system 20, 120, 220 to inaccurately specify an area detected by the system 20, 120, 220, e.g., a phenomenon referred to as Lidar “spoofing.” The system 20, 120, 220 and method reduces interference of light generated from a source other than the light emitter 30 by generating light having the intensity pattern 34. For example, the computer 38 analyzes data specifying the intensity profile of detected light to determine whether such data indicates detection of light from the light emitter 30.

The Lidar system 20, 120, 220 emits light and detects the emitted light that is reflected by an object, e.g., pedestrians, street signs, vehicles, etc. Specifically, the system 10 includes a light-transmission system 62 and a light-receiving system 64. The light-transmission system 62 includes the light emitter 30 that emits for illuminating objects for detection. The light-transmission system 62 includes an exit window 24 and includes transmission optics, i.e., focusing optics, between the light emitter 30 and the exit window 24. The computer 38 is in communication with the light emitter 30 for controlling the emission of light from the light emitter 30. In some examples, the computer 38 is in communication with light-intensity pattern element 32 for applying the pattern 34 in the intensity of light emitted through the exit window 24. The transmission optics shape the light from the light emitter 30 and guide the light through the exit window 24 to the field of illumination FOI.

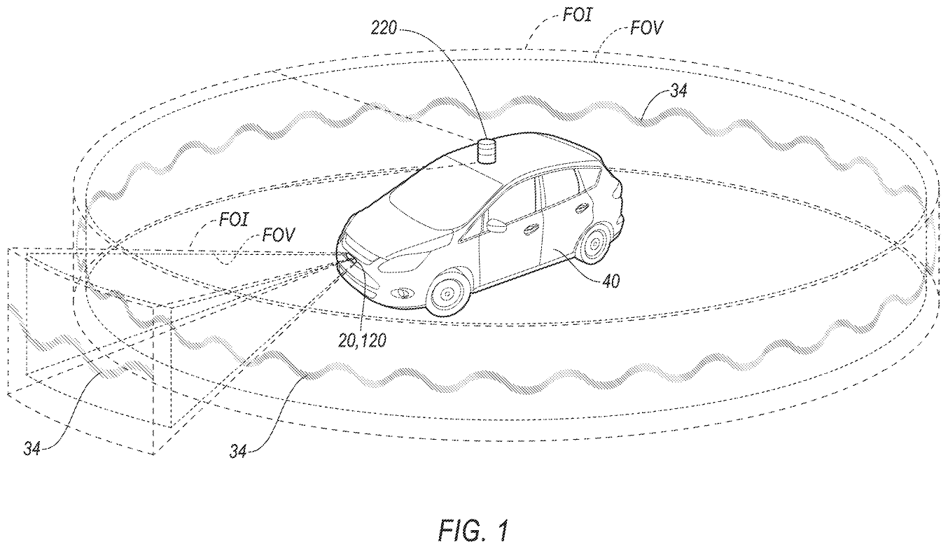

The systems 20, 120, 220 are shown in FIG. 1 as being mounted on the vehicle 40. In such an example, the systems 20, 120, 220 are operated to detect objects in the environment surrounding the vehicle 40 and to detect distance of those objects for environmental mapping. The output of the Lidar systems may be used, for example, to autonomously or semi-autonomously control operation of the vehicle 40, e.g., propulsion, braking, steering, etc. Specifically, the Lidar systems 20, 120, 220 may be a component of or in communication with an advanced driver-assistance system (ADAS) of the vehicle 40. The Lidar systems 20, 120, 220 may be mounted on the vehicle 40 in any suitable position and aimed in any suitable direction. As one example, the system 20, 120 is shown on the front of the vehicle 40 and directed forward. As another example, the system 220 is shown on a roof of the vehicle 40. The vehicle 40 shown in the Figures is a passenger automobile. As other examples, the vehicle 40 may be of any suitable manned or un-manned type including a plane, satellite, drone, watercraft, etc.

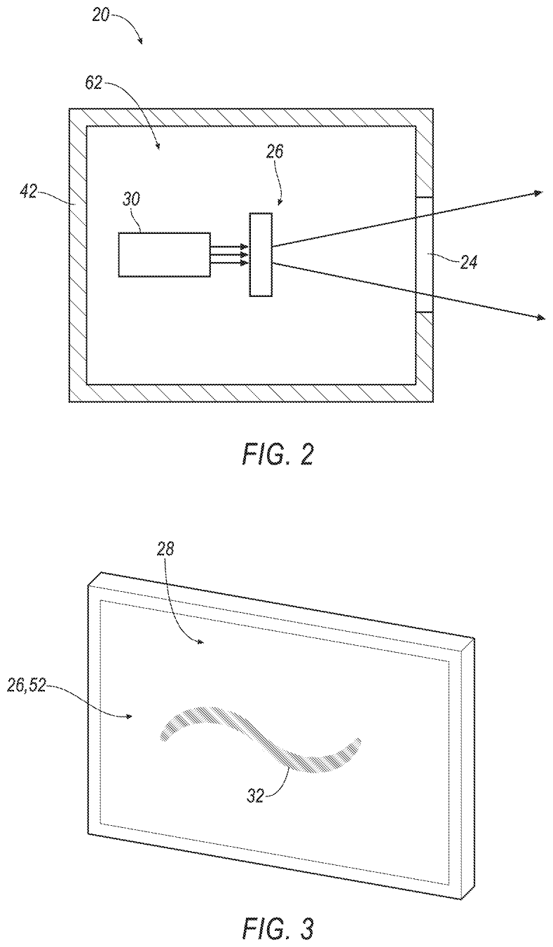

The system may be a solid-state Lidar system (see systems 20, 120 in FIGS. 2-7), e.g., a flash Lidar system, or may be a scanning Lidar system (see system 220). In the example shown in FIG. 1, the vehicle 40 includes one solid-state Lidar system 20, 120 and on scanning Lidar system 220 by way of example, and the vehicle 40 may include one system or a combination of any number of systems.

The solid-state Lidar system is stationary relative to the vehicle 40. For example, the Lidar system 20, 120 may include a casing 42 that is fixed relative to the vehicle 40, i.e., does not move relative to the component of the vehicle 40 to which the casing 42 is attached, and a silicon substrate of the Lidar system is supported by the casing 42. As set forth above, as a solid-state Lidar system, the Lidar system 20, 120 may be a flash Lidar system. In such an example, the Lidar system 20, 120 emits flashes, i.e., pulses, of light into the field of illumination FOI. As an example, the Lidar system 20, 120 may be a 3D flash Lidar system that generates a 3D environmental map of the surrounding environment based on detecting reflected light from an emitted flash.

As another example, the system may be a scanning Lidar system (see system 220 in FIG. 8). As a scanning Lidar system, the light-transmission system 62 of the Lidar system 220 includes one or more light emitters 30 and one or more spinning mirrors 66 and aim light from the light emitter 30 through the exit window 24. In such an example, the field of illumination FOI surrounds the vehicle, i.e., is in 360 degrees. In such an example, the light-receiving system 64 of the Lidar system 220 may include a plurality of image sensors 50 each including arrays of the photodetectors 22.

As shown in FIG. 1, the light-receiving system 64 has a field of view FOV that overlaps the field of illumination FOI of the light-transmission system 62 and receives light reflected by objects in the FOV. The light-receiving system 64 may include receiving optics and includes the light sensor 50 having the photodetector(s) 22. The light-receiving system 64 may include a receiving window and receiving optics between the receiving window and the photodetector(s) 22. The receiving optics may be of any suitable type.

The light sensor 50 includes a silicon chip and the photodetector(s) 22 on the silicon chip, as is known. The photodetector(s) 22 may be 2-dimensional. Specifically, the photodetector(s) 22 includes a plurality of photodetectors arranged in a columns and rows. Each photodetector is light sensitive. Specifically, each photodetector detects photons by photo-excitation of electric carriers. An output signal from the photodetector indicates detection of light and may be proportional to the amount of detected light. The output signals of each photodetector are collected to generate a scene detected by the photodetector. The photodetectors may be of any suitable type, e.g., photodiodes (i.e., a semiconductor device having a p-n junction or a p-i-n junction) including avalanche photodiodes, metal-semiconductor-metal photodetectors, phototransistors, photoconductive detectors, phototubes, photomultipliers, etc. As an example, the photodetectors may each be a silicon photomultiplier (SiPM). As another example, the photodetectors may each be or a PIN diode. Each photodetector may also be referred to as a pixel.

The photodetector(s) 22 detects light reflected by objects in the field of view FOV to generate data specifying characteristics of the detected light and specifying the objects reflecting such light. Example characteristics include intensity, wavelength, and time of detection. The time of detection may be used along with a time of transmission of the light by the light emitter 30 to perform time-of-flight calculations for determining distances to the objects reflecting the detected light. The intensity of the detected light may vary across a detection surface of the photodetector(s) 22. In other words, light detected by one portion of the photodetector(s) 22 may have a different intensity as compared to light detected by another portion of the photodetector(s) 22. For example, the photodetector(s) 22 may capture data specifying an intensity profile of the reflected light, i.e., an intensity array that shows varying intensity of reflected light detected by the photodetector(s) 22 relative to positions along vertical and horizontal axes. Intensity is the return strength, or brightness, of the reflected light. In examples in which the Lidar system is a solid-state Lidar system, e.g., systems 20, 120, the data specifying the intensity profile and objects reflecting light may be generated from a single capture of light reflected in the field of view FOV. In examples in which the Lidar system is a scanning Lidar system, e.g., system 220, the data specifying an intensity profile and objects reflecting light may be a compilation of multiple captures. The capture or compilation of multiple captures may be compiled into a 3D environmental map field of detected objects.

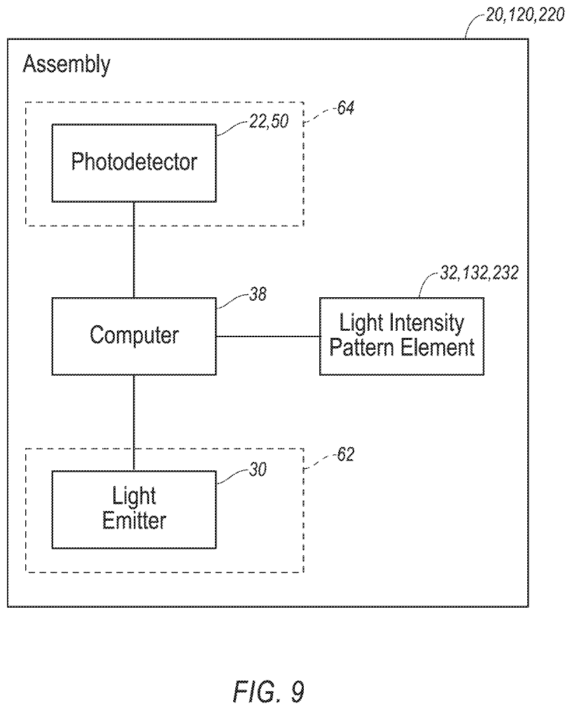

The Lidar system 20, 120, 220 may be a unit. For example, the Lidar system 20, 120, 220 may include a casing 42 that encloses the components of the Lidar system 20, 120, 220 and may include mechanical attachment features to attach the casing 42 to the vehicle 40 and electronic connections to connect to and communicate with electronic system of the vehicle 40, e.g., components of the ADAS. The examples shown in FIGS. 2, 6, and 8, the show the light-transmission system 62 supported in by the casing 42, and the light-detecting system 64 (shown in FIG. 9) is also supported in the casing 42 in examples in which the Lidar system 20, 120, 220 is a unit. The casing 42 may house the photodetector(s) 22, the optical elements 26, the light emitter 30, the light-intensity pattern element 32, etc. The exit window 24 may include an aperture extending through the casing 42 and may include a lens in the aperture. The exit window 24 is positioned to transmit light from the light-shaping region 28 into the field of view FOV. In other words, the field of illumination FOI of light traveling from light-shaping region 28 through the exit window 24 overlaps the field of view FOV.

The casing 42, for example, may be plastic or metal and may protect the other components of the Lidar system from environmental precipitation, dust, etc. In the alternative to the Lidar system being a unit, components of the Lidar system, e.g., the light emitter 30 and the light-receiving system, may be separated and disposed at different locations of the vehicle 40.

The light emitter 30 emits light that is projected from the exit window 24 into the field of illumination FOI for detection by the light-receiving unit, e.g., by the photodetector(s) 22, when the light is reflected by an object in the field of view FOV. The light emitter 30 may be, for example, a laser. The light emitter 30 may be, for example, a semiconductor laser. In one example, the light emitter 30 is a vertical-cavity surface-emitting laser (VCSEL). As another example, the light emitter 30 may be a diode-pumped solid-state laser (DPSSL). As another example, the light emitter 30 may be an edge emitting laser diode. The light emitter 30, for example, may be designed to emit a pulsed flash of light, e.g., a pulsed laser light. Specifically, the light emitter 30, e.g., the VCSEL or DPSSL or edge emitter, is designed to emit a pulsed laser light. As another example, the light emitter 30 may be a continuous wave (CW) laser. The light emitted by the light emitter 30 may be, for example, infrared light. Alternatively, the light emitted by the light emitter 30 may be of any suitable wavelength. The Lidar system may include any suitable number of light emitters 30, i.e., one or more in the casing 42. In examples that include more than one light emitter 30, the light emitters 30 may be identical or different.

The light emitter 30 may be stationary relative to the casing 42, e.g., in examples in which the light emitter 30 emits a pulsed flash of light. In other words, the light emitter 30 does not move relative to the casing 42 during operation of the system, e.g., during light emission. The light emitter 30 may be mounted to the casing 42 in any suitable fashion such that the light emitter 30 and the casing 42 move together as a unit.

As set forth above, the light emitter 30 is aimed at the optical element 26. Specifically, the light emitter 30 is aimed at the light-shaping region 28 of the optical element 26. The light emitter 30 may be aimed directly at the optical element 26 or may be aimed indirectly at the optical element 26 through intermediate reflectors/deflectors, diffusers, optics, etc. Light from the light emitter 30 is transmitted through and exits the light-shaping region 28 or is externally reflected by the light-shaping region 28. Specifically, when transmitted through the light-shaping region 28, the light from the light emitter 30 enters a front side of the optical element 26 and exits a back side of the optical element 26, and the optical element 26 shapes the light. When reflected by the light-shaping region 28, the light from the light emitter 30 is externally reflected by the light-shaping region 28.

The light-shaping region 28 of the optical element 26, specifically a light-shaping surface, shapes the light, e.g., by diffusion, scattering, etc. The light-shaping region 28 may be transmissive, i.e., transmits light from the light emitter 30 through the light-shaping region 28. In other words, the optical element 26 is designed to transmit light from the light emitter 30. As another example, the light-shaping region 28 may be reflective, i.e., reflects light from the light emitter 30. In other words, the optical element 26 is designed to reflect light from the light emitter 30. In an example in which the light-shaping region 28 is reflective and the optical element is a monolithic optical lens, e.g., glass or plastic, the light-shaping surface may be a coating on a relatively less transmissive substrate, e.g., glass or plastic.

The optical element 26 shapes light that is emitted from the light emitter 30. Specifically, the light emitter 30 is aimed at the optical element 26, i.e., substantially all of the light emitted from the light emitter 30 reaches the optical element 26. As one example of shaping the light, the optical element 26 diffuses the light, i.e., spreads the light over a larger path and reduces the concentrated intensity of the light. In other words, the optical element 26 is designed to diffuse the light from the light emitter 30. As another example, the optical element 26 scatters the light, e.g., a hologram). Light from the light emitter 30 may travel directly from the light emitter 30 to the optical element 26 or may interact with additional components between the light emitter 30 and the optical element 26. The shaped light from the optical element 26 may travel directly to the exit window 24 or may interact with additional components between the optical element 26 and the exit window 24 before exiting the exit window 24 into the field of illumination FOI.

The light-intensity pattern element 32 is designed to apply the pattern 34 in the intensity of light across the field of illumination FOI. In other words, the light-intensity pattern element 32 varies the light intensity within a single field of illumination. The pattern 34 may extend partially across or entirely across the field of illumination FOI. The light-intensity pattern element 32 may selectively block, reflect light, and/or attenuate light from the light emitter 30 to generate the pattern 34 in the field of illumination FOI.

The pattern 34 in the intensity of light, also referred to as the intensity pattern 34, is an area within the light emitted by the system 20, 120, 220 having a different intensity, e.g., brightness, as compared to a remainder of the light emitted by the system 20, 120, 220 in the same field of illumination FOI. The intensity pattern 34 may be a specified shape, symbol, etc., e.g., viewable in 2-dimensional space that is transverse e.g., normal, to a direction of travel for the light emitted from the exit window 24. The 2-dimensional space may curve around the system, e.g., when the system 220 is a scanning Lidar system. The intensity pattern 34 may be light that has a lower intensity than the remainder of light emitted from the exit window 24. For example, the intensity pattern 34 may be 10% less bright than the remainder of light emitted from the exit window 24, e.g., as measured in lux.

The light-intensity pattern element 32 may be on the light-shaping region 28 of the optical element 26. Specifically, in the example shown in FIG. 3, the light-intensity pattern element 32 is on the light-shaping region 28 of the monolithic lens 52. As set forth above, the optical element 26 shown in FIG. 3 is a monolithic lens 52 (e.g., a one-piece monolithic lens formed of glass or plastic). In such examples, the monolithic lens 52 may be of any suitable type that shapes light from the light emitter 30 toward the exit window 24. For example, the monolithic lens 52 may be or include a diffractive optical element, a diffractive diffuser, a refractive diffuser, a blazed grating, etc.

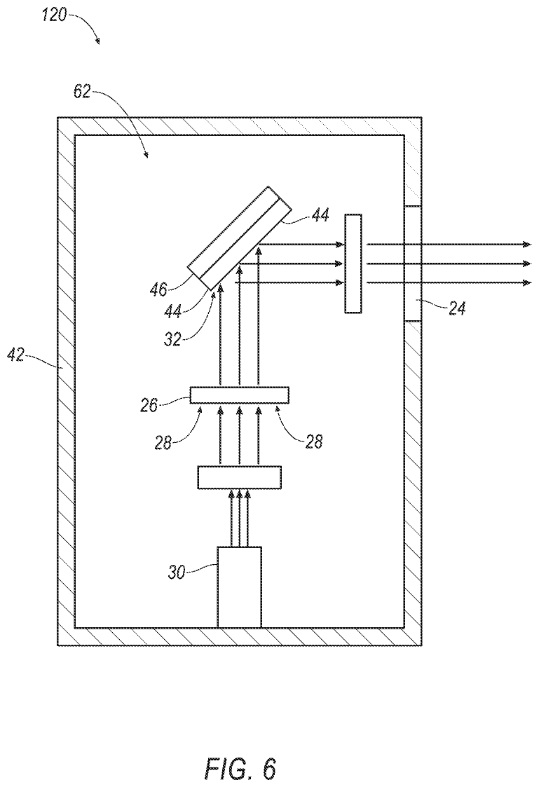

For example, the light-intensity pattern element 32 may be an etching, added polymer, holographic element, or other suitable structure on the light-shaping region 28 of the monolithic lens 52 that restricts the transmission or reflection of light to generate the light-intensity pattern 34 in the field of view FOI. The monolithic lens 52 may be transmissive, for use in the system 20 of FIG. 2. In such an example, the light-intensity pattern element 32 restricts the transmission of light relative to the rest of the monolithic lens 52 to create the pattern 34 in the field of illumination FOI. As another example, the monolithic lens 52 may be reflective, in which case the monolithic lens 52 may be used in a system similar to system 120 shown in FIG. 6. In such an example, the light-intensity pattern element 32 restrict the reflection of light relative to the rest of the monolithic lens 52 to create the pattern 34 in the field of illumination FOI.

With reference to FIGS. 4 and 4A, as another example, the optical element 26 may be a liquid-crystal lens 54 having a light-shaping region 28 including an array of liquid-crystal pixels 56. In such an example, a portion of the array of liquid-crystal pixels 56 forms the light-intensity pattern element 32. The liquid-crystal pixels 56 generate the pattern 34 by changing reflectivity and/or transmissivity in specified areas and/or shapes to generate the light-intensity pattern 34 in the field of illumination FOI. The liquid-crystal lens 54 may generate a variety of patterns 34, e.g., depending on an electrical field applied to the liquid-crystal pixels 56. The electrical field may be applied, for example, in response to a command from the computer 38. Any number of the liquid-crystal pixels 56 may be controlled to form the light-intensity pattern element 32 for any field of illumination FOI, and different ones of the liquid-crystal pixels 56 may be controlled to form different patterns in any given field of illumination FOI. The liquid-crystal lens 54 may be transmissive, for use in the system 20 of FIG. 2. In such an example, the light-intensity pattern element 32 restricts the transmission of light relative to the rest of the liquid-crystal lens 54, e.g., by adjusting electrical field to select crystal pixels 56, to create the pattern 34 in the field of illumination FOI. As another example, the liquid-crystal lens 54 may be reflective, in which case the liquid-crystal lens 54 may be used in a system similar to system 120 shown in FIG. 6. In such an example, the light-intensity pattern element 32 restrict the reflection of light relative to the rest of the liquid-crystal lens 54 to create the pattern 34 in the field of illumination FOI.

With reference to FIGS. 5 and 5A, as another example, the optical element 26 may include an array of micro lenses 58 forming the light-shaping region 28. In such an example, the array of micro lenses 58 is the light-intensity pattern element 32. Specifically, in the example shown in FIGS. 5 and 5A, the light-intensity pattern element 32 is on the light-shaping region 28 of the array of micro lenses 58. For example, the light-intensity pattern element 32 may be formed by some of the lenses of the array of micro lenses 58 having different optical properties, i.e., reflectivity, transmissivity, etc., than the rest of the lenses of the array of micro lenses 58 to restrict the transmission or reflection of light and generate the light-intensity pattern 34 in the field of view FOI. The differences in optical properties may be fixed or may be adjustable, as described further below. The array of micro lenses 58 may be transmissive, for use in the system 20 of FIG. 2. In such an example, the light-intensity pattern element 32, i.e., select micro lenses having different optical properties than the rest of the micro lenses, restrict the transmission of light relative to create the pattern 34 in the field of illumination FOI. As another example, the array of micro lenses 58 may be reflective, in which case the array of micro lenses may be used in a system similar to system 120 shown in FIG. 6. In such an example, the light-intensity pattern element 32 restrict the reflection of light relative to the rest of the array of micro lenses 58 to create the pattern 34 in the field of illumination FOI.

With continued reference to FIGS. 5 and 5A, as set forth above, different optical properties of the micro lenses 58 that form the light-intensity pattern element 32 may be fixed. In other words, the array of micro lenses 58 is passive with all of the micro lenses fixed relative to each other, i.e., a passive array. As another example, the micro lenses 58 may be adjustable, e.g., by use of a microelectromechanical (MEMS) system 46 (see FIG. 6). In such an example, the adjustment of the micro lenses 58, e.g., in responses to a command from the computer 38, may change the position any one or more of the micro lenses 58 to change the reflection, diffusion, refraction, transmissivity, etc., of the array of micro lenses 58 in specified areas to generate the light-intensity pattern 34 in the light passing through/reflected by the light-intensity pattern element 32. For example, the MEMS 46 may change an angle of one or more of the micro lenses 58, thereby changing refraction/refection of light to change the light intensity pattern 34. Any number of the micro lenses 58 may be controlled to form the light-intensity pattern element 32 for any field of illumination FOI, and different ones of the micro lenses 58 may be controlled to form different patterns in any given field of illumination FOI.

With reference to FIGS. 7 and 7A, as another example, the optical element 26 includes an array of micro mirrors 60. In such an example, a portion of the array of micro mirrors 60 forms the light-intensity pattern element 32. For example, the micro mirrors 60 may be adjustable, e.g., by use of a microelectromechanical system (MEMS) 46 (see FIG. 6). In such an example, the adjustment of the micro mirror 60, e.g., in responses to a command from the computer 38, may change the position of any one of the micro mirrors 60 to change the reflectivity in specified areas of the array of micro mirrors 60 to generate the light-intensity pattern 34 in the light passing through/reflected by the light-intensity pattern element 32. For example, the MEMS 46 may change an angle of one or more of the micro lenses 58, thereby changing refection of light to change the light intensity pattern 34. Any number of the micro mirrors 60 may be controlled to form the light-intensity pattern element 32 for any field of illumination FOI, and different ones of the micro mirrors 60 may be controlled to form different patterns in any given field of illumination FOI.

With reference to FIG. 8, the light-intensity pattern element 32 may be a variable optical attenuator 48. The variable optical attenuator 48 selectively reduces intensity of light from the light element, e.g., in response to a command from the computer 38. The variable optical attenuator 48 may be continuously variable, and/or set-wise variable. For example, the variable optical attenuator 48 may include a liquid crystal variable attenuator (LCVA), a lithium niobite device, variable gap, or other suitable structure. The variable optical attenuator 48 may be commanded to reduced intensity of light from the light emitter 30 based on the transmitting direction of the emitted light, e.g., to selectively reduce light for some light pulses of a scanning Lidar system.

Returning to FIGS. 2, 4, and 6, the light-intensity pattern element 32 is between the light emitter 30 and the exit window 24 relative to a path of travel of light generated by the light emitter 30. The path of travel of light may be defined by a facing direction of the light emitter 30, one or more diffusers, reflectors, lens, optical elements 26, etc. For example, light may travel from the light emitter 30, to the light-intensity pattern element 32, e.g., to the variable optical attenuator 48, the array of micro lenses 58, the light-intensity pattern element 32 on the light-shaping region 28 of the optical element 26, etc., and then to the exit window 24. The light may travel to a from one or more diffusers, reflectors, lens, optical elements 26, etc., between the light emitter 30 and the light-intensity pattern element 32 and/or between the light-intensity pattern element 32 and the exit window 24.

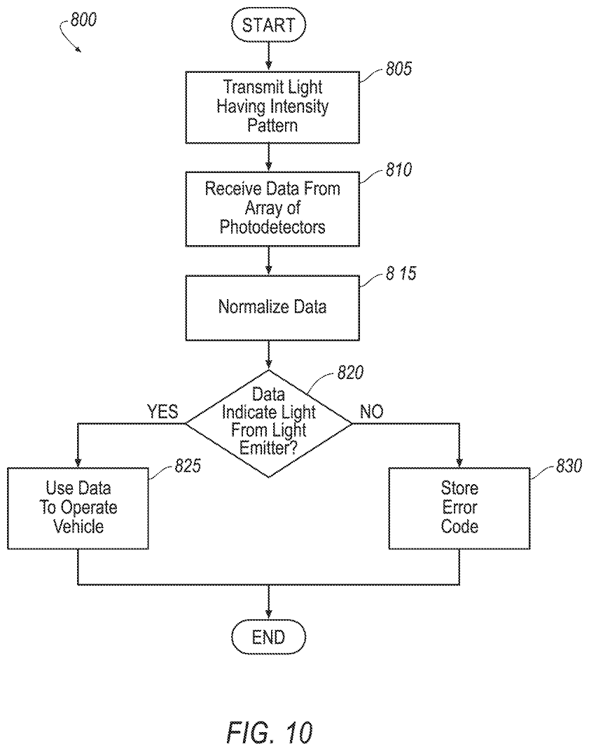

The computer 38 may be a microprocessor-based controller implemented via circuits, chips, or other electronic components. For example, the computer 38 may include a processor, memory, etc. The memory of the computer 38 may include memory for storing instructions executable by the processor as well as for electronically storing data and/or databases. The computer 38 may be in communication with a communication network of the vehicle 40 to send and/or receive instructions from the vehicle 40, e.g., components of the ADAS. The instructions stored on the memory of the computer 38 include instructions to perform the method in FIG. 10. Use herein (including with reference to the method in FIG. 11) of “based on,” “in response to,” and “upon determining,” indicates a causal relationship, not merely a temporal relationship.

The computer 38 is programmed to, i.e., the memory stores instructions executable by the processor to, activate the light emitter 30 to emit light. For example, the computer 38 may transmit a command specifying generation of a flash of light to the light emitter 30. The command to generate may specify light generation at a specific time, e.g., to coordinate the light generation with a position of the optical element 26, e.g., a rotational position of a mirror in the example in FIG. 8. The emitted light from the light emitter 30 travels to the light-intensity pattern element 32 and through the exit window 24. The light traveling through the exit window 24 has an intensity pattern 34 in the field of view FOV of the photodetector(s) 22.

The computer 38 may be programmed to actuate the light-intensity pattern element 32 to control the intensity pattern 34 of the light traveling through the exit window 24. For example, the computer 38 may transmit a command specifying the pattern 34 to the light-intensity pattern element 32. In the example shown in FIGS. 4 and 4A, in which some of the liquid-crystal lenses 54 of the array of liquid-crystal lenses 54 form the light-intensity pattern element 32, actuating the light-intensity pattern element 32 includes adjusting the electrical field to select crystal pixels 56 to create the pattern 34 in the field of illumination FOI. In examples including the MEMS 46, e.g., some examples of FIGS. 5-5A and 7-7A, the computer 38 may command the MEMS 46 to control the position of the micro lenses 58 or the micro mirrors 60 so as to operate as the light-intensity pattern element 32 to generate the intensity pattern 34 in the field of illumination FOI. In the example in FIG. 8 including the variable optical attenuator 48, actuating the light-intensity pattern element 32 includes commanding the variable optical attenuator 48 to reduce intensity of one or more light pulses from the light emitter 30 while a rotational mirror is at one or more specified positions, and to not reduce intensity of one or more light pulses while the rotational mirror is at other positions. The variable optical attenuator 48 may reduce the intensity of the one or more light pulses by an amount specified in the command, e.g., 10%. As another example, the computer 38 may be programmed to modulate light emitter 30 itself, e.g., the diode or laser source, to reduce the intensity of the light emitted by the light emitter 30. For example, a scanner may have the diode modulate intensity as the scanner spins.

The computer 38 may be programmed to receive and normalize the intensity profile of data specifying light detected by the plurality of pixels of the photodetector(s) 22 to remove the intensity pattern 34 of the light emitted by the light emitter 30. Normalizing the intensity profile provides data that specifies light that would have been detected by the photodetector(s) 22 if the Lidar system generated light without the light-intensity pattern element 32. For example, the computer 38 may alter the data to specify an increased intensity of a specified amount for specified pixels field of illumination FOI, e.g., adding intensity that corrects for the decreased intensity of the light by the light-intensity pattern element 32. The computer 38 may normalize the intensity profile based on data specifying the intensity pattern 34 and stored in memory. The data specifying the intensity pattern 34 may include data specifying the same intensity pattern 34 as included in the light generated by the Lidar system. The data specifying the intensity pattern 34 may be stored in memory, and the computer 38 may use the intensity pattern 34 to control the light-intensity pattern element 32 and to normalize the data generated from the detect light. The stored intensity pattern 34 may be generated during calibration of the Lidar system, e.g., when one or more the light-intensity pattern elements 32 having fixed patterns 34, e.g., the etching, added polymer, holographic element, etc., on the monolithic lens 52 or the fixed micro lenses 58 in some examples of FIG. 5. Light from the Lidar system may be analyzed to determine the light intensity pattern 34, and such pattern 34 may be stored in memory. The pattern 34 may be dynamic, e.g., the computer 38 may vary the light intensity pattern 34 for the emitted light and for normalizing the data based on an equation or the like that varies the intensity pattern 34, e.g., using a sine wave or the like and with respect to time.

The computer 38 is programmed to receive data from the photodetector(s) 22, the data specifying the intensity profile of detected light and indicating detection of light from the light emitter 30 that was reflected in the field of view FOV. For example, the computer 38 may be programmed to determine that light detected by the photodetector(s) 22 is light the emitted by the light emitter 30 based on the data from the photodetector(s) 22 specifying an indication of the pattern 34.

The computer 38 may be programmed to identify the indication of light from the light emitter 30 by comparing the intensity profile of the data specifying light detected by the plurality of pixels field of illumination FOI of the photodetector(s) 22 with the intensity pattern 34 of the emitted light traveling through the exit window 24, i.e., with the pattern 34 applied by the light-intensity pattern element 32. The computer 38 may identify the intensity profile of the detected light by comparing light intensities detected by the photodetector(s) 22 with each other. For example, the computer 38 may identify certain photodetectors 22 that detect light at lower intensity than adjacent photodetectors 22. The computer 38 may compile the data from all photodetectors 22 that detect lower light intensity with each other to identity the pattern in the intensity profile. Other techniques may be used to identify the pattern the intensity profile in the data. The computer 38 may compare the identified pattern in the intensity profile with the intensity pattern 34 stored in memory. For example, the computer 38 may compare the intensity profile of data specifying light detected by the photodetector(s) 22 with the pattern 34 applied by light-intensity pattern element 32. As one example, the comparison identifies spoofing, sun light, or other external light source. The computer 38 may calculate a probability that the light is from one of these external light sources and may base decisions on the probability. The computer 38 may identify the detected light as indicating detection of the of light from the light emitter 30 when the intensity profile in the data substantially matches the intensity pattern 34, e.g., when the intensity profile of the data and the intensity pattern 34 have a threshold amount of similarity, e.g., 95%. The threshold amount of similarity may be determined by empirical real world and/or simulation testing, e.g., using detected light having the pattern 34 and detected light not having the pattern 34.

The computer 38 may be programmed to identify the indication by comparing a light intensity specified by the normalized data with a threshold. For example, when the normalized data specifies detection of light from the light emitter 30, the normalized light intensity should be lower than a specified amount. In other words, when light not emitted from the light emitter 30 is detected, normalizing data of such detected light may provide data specifying light intensity greater than what could have possibly generated by the light emitter 30. As a numerical example, the light emitter 30 may generate light at 10 lux, and the light-intensity pattern element 32 may reduce light intensity for the intensity pattern 34 to 9 lux. The computer 38 may normalize the data in the detected light based on the intensity pattern 34 by 1 lux, e.g., such that the detected light should have an intensity of 10 lux. Normalized data indicating an intensity over 10 lux indicates the detected light is not from the light emitter 30. The threshold may be stored in memory, e.g., based on characteristics of the light emitter 30. The computer 38 may determine the threshold, e.g., based on detected light intensity spaced from the intensity pattern 34, based on detected light intensity over time, etc.

FIG. 8 is a process flow diagram illustrating an exemplary process 800 for operating the system 20, 120, 220. The process 800 begins in a block 805 where the computer 38 actuates the system 20, 120, 220 to transmit light having a light-intensity pattern 34. For example, the computer 38 may command the light emitter 30 to generate one or more flashes of light, the light traveling from the light emitter 30 to the light-intensity pattern element 32, and then out the exit window 24. Additionally, the computer 38 may actuate the light-intensity pattern element 32 to control the intensity pattern 34 of the light, e.g., as described herein.

Next, at a block 810 the computer 38 receives data from the photodetector(s) 22. The data specifies the light intensity profile of light detected by the plurality of pixels the photodetector(s) 22. The data may further specify time of receipt of the detected light (to calculate time of flight), etc.

At a block 815 the computer 38 normalizes the data from the photodetector(s) 22 received at the block 810 to remove the intensity pattern 34 of the light emitted by the light emitter 30. The computer 38 may normalize the data by selectively increasing the intensity of the detected light, e.g., based on the intensity pattern 34 and as described herein.

At a block 820 the computer 38 determines whether the data received at the block 810 and/or normalized at the block 815 indicates detection of light from the light emitter 30 that was reflected in the field of view FOV. For example, the computer 38 may compare the light intensity profile of light detected by the plurality of pixels of the photodetector(s) 22 at the block 810 with the intensity pattern 34 of the light transmitted at the block 805. As another example, the computer 38 may compare the intensity of the normalized data from the block 815 with a threshold, e.g., as described herein. Upon determining the data indicates detection of light from the light emitter 30 the process 800 moves to a block 825. Upon determining the data does not indicate detection of light from the light emitter 30 the process 800 moves to a block 830.

At the block 825 the computer 38 uses the normalized data to operate the vehicle 40. For example, the computer 38 may use the normalized data to autonomously navigate the vehicle 40, to determine to if an obstruction is present on an external lens of the Lidar system, etc., e.g., using conventional techniques.

At the block 830 the computer 38 may refrain from using the normalized data to autonomously navigate the vehicle 40, etc., and/or may store an error code specifying detection of light above a threshold, detection of light having intensity profile that does not match the intensity pattern 34, etc. After the block 830 the process 800 may end. Alternately, the process may return to the block 805.

Computing devices, such as the computer generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, computing modules, etc.), stored on computer readable media associated therewith (e.g., disks, memories, etc.). A computer program product may comprise such instructions stored on computer readable media for carrying out the functions described herein.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A Lidar system, comprising:
a photodetector having a field of view;
a light emitter;
an exit window positioned to transmit light from the light emitter into a field of illumination overlapping the field of view; and
a light-intensity pattern element between the light emitter and the exit window and designed to apply a pattern in the intensity of light across the field of illumination.

2. The Lidar system of claim 1, further comprising a computer having a processor and memory storing instructions executable by the processor to normalize an intensity profile of data specifying light detected by the photodetector to remove the pattern applied by the light-intensity pattern element.

3. The Lidar system of claim 2, wherein the memory stores instructions executable by the processor to compare light intensity specified by the normalized data with a threshold.

4. The Lidar system of claim 1, further comprising a computer having a processor and memory storing instructions executable by the processor to compare an intensity profile of data specifying light detected by the photodetector with the pattern applied to the field of illumination by the light-intensity pattern element.

5. The Lidar system of claim 1, further comprising a monolithic lens having a light-shaping region, the light-intensity pattern element is fixed to the light-shaping region.

6. The Lidar system of claim 1, further comprising an optical element having a light-shaping region including an array of micro lenses, the array of micro lenses being the light-intensity pattern element.

7. The Lidar system of claim 1, further comprising an optical element having a light-shaping region including an array of liquid-crystal pixels, the array of liquid-crystal pixels being the light-intensity pattern element.

8. The Lidar system of claim 1, wherein the light-intensity pattern element is a variable optical attenuator.

9. The Lidar system of claim 1, further comprising a computer having a processor and memory storing instructions executable by the processor to control the pattern applied to the intensity of light with an array of micro lenses, and to compare an intensity profile of data specifying light detected by the photodetector with the pattern applied by the array of micro lenses.

10. A Lidar system, comprising:
a photodetector having a field of view;
an optical element having a light-shaping region;
a light emitter aimed at the light-shaping region;
an exit window positioned to transmit light from the light-shaping region into a field of illumination overlapping the field of view; and
means for applying a pattern in the intensity of light across the field of illumination.

11. A computer comprising a processor and a memory storing instructions executable by the processor to:
activate a light emitter to emit light, the emitted light traveling through an exit window, the light traveling through the exit window having an intensity pattern across a field of illumination overlapping a field of view of a photodetector;
receive data from the photodetector indicating detection of light from the light emitter that was reflected in the field of view, the data specifying an intensity profile; and
normalize the data from the photodetector to remove the intensity pattern of the light emitted by the light emitter.

12. The computer of claim 10, wherein the memory stores instructions executable by the processor to actuate a light-intensity pattern element to control the intensity pattern of the light traveling through the exit window.

13. The computer of claim 10, wherein the memory stores instructions executable by the processor to compare the intensity profile of the data with the intensity pattern of the light traveling through the exit window.

14. The computer of claim 10, wherein the memory stores instructions executable by the processor to adjust an array of micro lenses to control the intensity pattern of the light traveling through the exit window.

15. The computer of claim 13, wherein the memory stores instructions executable by the processor to compare the intensity profile of the data with the intensity pattern generated by the micro lenses.

16. The computer of claim 10, wherein the memory stores instructions executable by the processor to adjust a variable optical attenuator to control the intensity pattern of the light traveling through the exit window.

17. A method comprising:
activating a light emitter to emit light, the emitted light having an intensity pattern across a field of illumination overlapping a field of view of a photodetector;
receiving data from the photodetector indicating detection of light from the light emitter that was reflected in the field of view, the data specifying an intensity profile; and
normalizing the data from the photodetector to remove the intensity pattern of the light emitted by the light emitter.

18. The method of claim 15, further comprising comparing the intensity profile of the data with the intensity pattern of the emitted light.

19. The method of claim 15, further comprising adjusting an array of micro lenses to control the intensity pattern of the emitted light.

20. The method of claim 17, further comprising comparing the intensity profile of the data with the intensity pattern generated by the micro lenses.

21. The method of claim 15, further comprising adjusting a variable optical attenuator to control the intensity pattern of the emitted light.
